(19) United States
(12) Patent Application Publication
(10) Pub. No.: US 2011/0182710 A1
(43) Pub. Date: Jul. 28, 2011

(54) DEVICE FOR SWIVELING A BOTTLE WHICH IS CONVEYED IN A GRIPPER

(75) Inventors: Andreas Fahldieck, Idar-Oberstein (DE); Peter Fried, Buxtehude (DE); Roland Topf, Schönebeck (DE)

(73) Assignee: KHS GmbH, Durtmund (DE)

(21) Appl. No.: 13/119,982

(22) PCT Filed: Sep. 11, 2009
(86) PCT No.: PCT/EP09/06591

§ 371 Date: Mar. 21, 2011

(30) Foreign Application Priority Data
Oct. 21, 2008 (DE) 10 2008 052 614.2

(51) Int. Cl. B65G 47/248

(52) U.S. Cl. 414/758

(57) ABSTRACT

The invention relates to a device (1) for swiveling a bottle (2) from a suspended position to an overhead position and back, said bottle being conveyed in a gripper. The aim of the invention is to devise a device of the above type which is compact for the bottles conveyed in the grippers so that it can be used in a different station where it is necessary to swivel the bottle but not necessarily to supply it to a rinser. The device according to the invention has a gripper (4) which is mounted on a rotational element (6) having a shaft (7), a gear or the like actively connected supporting arm (5), the rotational element (6) being driven by a drive element (8) and being arranged on a spider (12) or the like which is located in immediate proximity outside the rinser (3).

The invention relates to a device for pivoting a bottle being conveyed in a gripper out of a suspended position into an inverted position and back.

If bottles being conveyed in a suspended position are to be supplied, for example, to a rinser, it is necessary to pivot the bottles out of the suspended position into an inverted position so that the spray devices of the rinser can wash out the interior of a bottle positioned in this manner. Once the cleaning has been effected the bottles then have to be pivoted back into the corresponding position making the suspended conveying possible.

Such a device is known, for example in DE 94 11 971, where the bottles are pivoted in a corresponding manner in the rinser by means of a push rod/pinion drive. Turning devices for blow moulded preforms are shown in DE 297 08 808 U1 or DE 100 17 050 A.

One particular disadvantage of the known devices is that because of the integrated turning device, the rinsers or the corresponding devices have to be comparatively large and consequently require an increased amount of installation space.

This is where the invention fits in, the object of which is to create as compact as possible a pivoting device for the bottles being conveyed in the grippers, it also being possible to use said device at another position if pivoting is required but being supplied to a rinser is not necessary.

By way of a device of the aforementioned type, said object is achieved according to the invention in that the gripper is provided on a rotational element with a shaft, a gear wheel or similarly operatively connected support arm, wherein the rotational element is acted upon by a drive element and is located at a star or the like, which is positioned in the direct vicinity outside the rinser.

In this case, the particular advantage of the development according to the invention is that it is possible to rotate the star freely on the one side and to rotate the rinser/spray head freely on the other without them having to collide, even when, for example, said two elements are operated in an asynchronous manner, e.g. when they do not have any bottles or when one of the devices is at a standstill.

In one particular development the invention provides that the star with corresponding rotational elements for pivoting the respective bottle into an inverted position and the star for pivoting the respective bottle back are positioned in a contact-free manner next to the rinser.

One of the possible developments of the invention is that the rotational element is formed by a gear wheel and the drive element is formed by a push rod that is provided with corresponding teeth, this solution being known per se, e.g. in the already mentioned DE 94 11 971 U1.

Developments of said push rod technology are produced in the following claims, it being possible to distinguish one corresponding device in that the drive element is formed by a cable or belt that is acted upon by a push rod.

In this case it can also be provided that the push rod is provided on its free end with a guide element, in particular a wheel roller and/or that the wheel roller is acted upon by a rocker face for exerting a thrust movement onto the push rod.

In an expedient manner, the push rod can be provided with a restoring spring, it being possible for the entire device to be surrounded by a guard rail, as is also provided by the invention.

A further variant of the invention is that the rotational element is pivoted by a spring-loaded gripping arm, which, as known per se, is provided with a C-shaped sliding claw which is in engagement with a guide rod, a sliding clamp with a guide rod being known per se in commercial solutions provided by the applicant.

The invention also provides that the gripper is realized as an active or passive gripper for grasping the bottle neck.

If the grippers are provided on a gripper carrier, the invention also provides that the gripper carrier is mounted so as to be at least slightly resilient or rotatable on both sides in its horizontal direction, in order in this manner, where there is asynchronicity between the delivery and take-over gripper, to be able to compensate for the corresponding gaps, or in order to be able to adapt to certain different bottle neck diameters at least above a certain clearance.

The invention is explained below as an example by way of the drawing, in which, in detail:

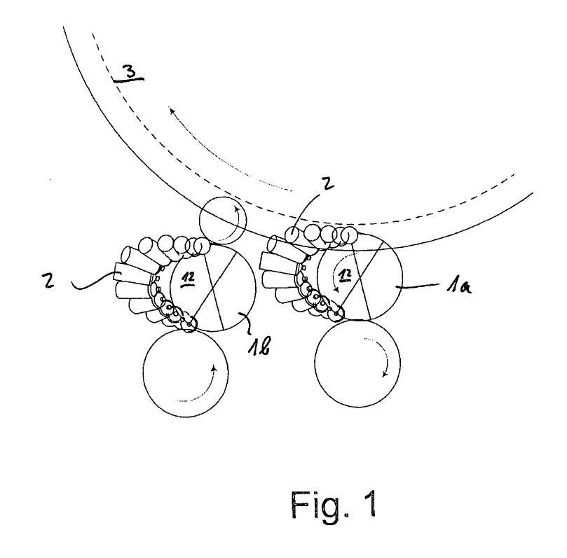

FIG. 1 shows a basic view of devices according to
a) the invention in the region of a rinser with bottles
b) indicated in the different pivot positions,

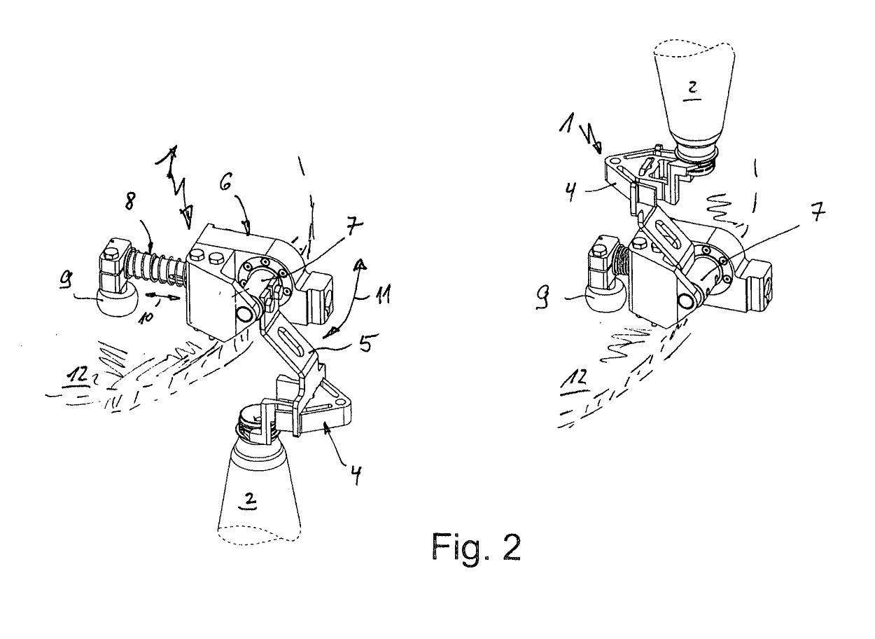

FIG. 2 shows an element of a pivoting device according
a) to a first exemplary embodiment, in two different
b) bottle positions,

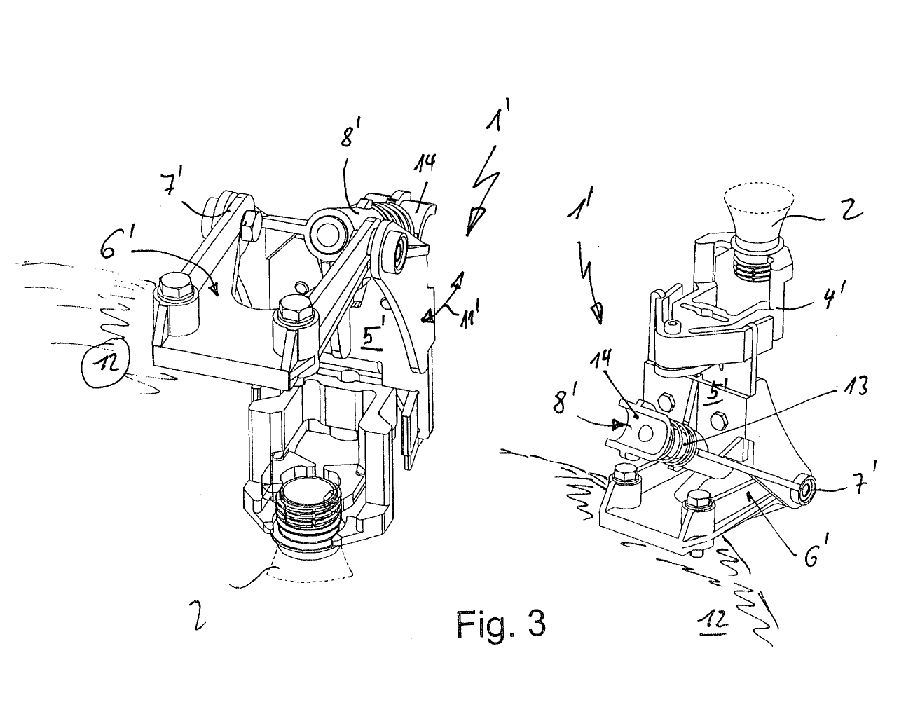

FIG. 3 shows another exemplary embodiment of the invention
a) for pivoting with the bottle into different
b) pivot positions and

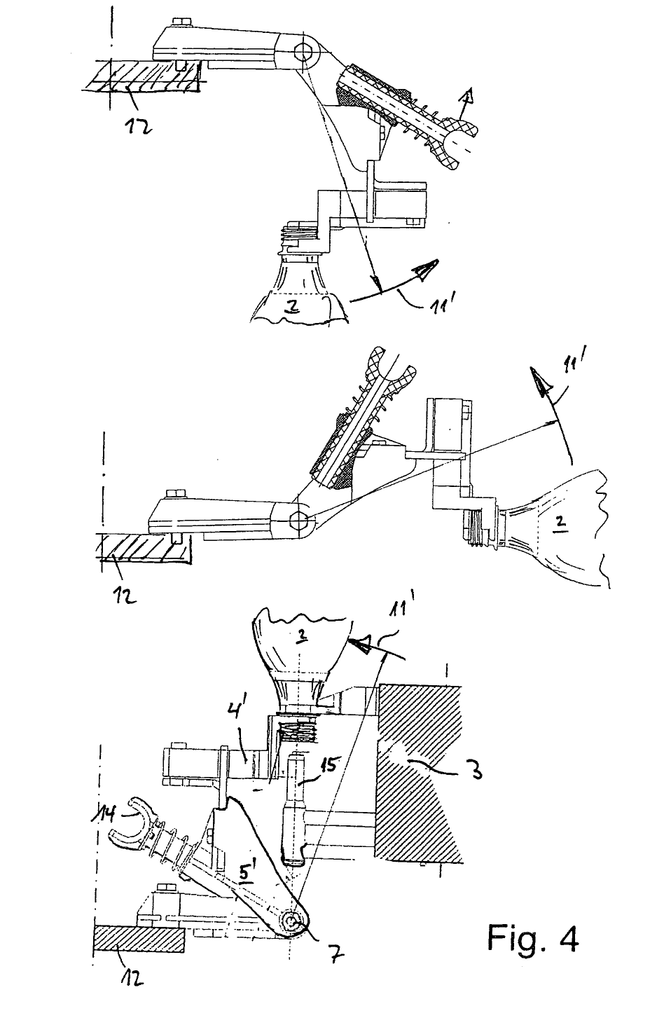

FIG. 4 shows a side view of the sequence of the pivoting operation
a) from the suspended conveying position into the inverted
b) position of the bottle via a spray nozzle
c) of the rinser.

FIG. 1 represents a basic view of the positioning of the devices for pivoting bottles 2, said devices being given the references 1a and 1b, with reference to a rinser 3 that is indicated by two sectors of a circle, the bottles 2 initially being pivoted from a suspended position, FIG. 1 left-hand side, into an inverted position in order then, after running through the rinser, to be pivoted back from the inverted position into the suspended position (FIG. 1, right-hand side). It can be seen that the devices 1a or 1b are moved very close to the rinser without however contacting said rinser and this is described in more detail below.

It can be seen that the bottle is not pivoted, as known in the prior art, in the rinser itself but rather in one of the stars that are located upstream or downstream such that it is possible to keep the stars very compact even with the corresponding devices 1a or 1b.

With reference to the left-hand side Figure, FIG. 2 shows how the bottle 2 is grasped in the head region by a gripper, which is given the general reference 4, the gripper 4 being held on a support arm which is operatively connected to a shaft 7 by a rotational element, given the general reference 6.

The rotational element 6, in the design in FIG. 2, is at the same time acted upon by a drive element 8. In this case, for example, this is the toothed rack with corresponding pinion as rotational shaft 6, the toothed rack of the drive element 8 being provided with a roller wheel, which can be displaced in opposition to the force of the spring by a rocker face such that it can be displaced to the right as shown by the double arrow 10, FIG. 2 left-hand representation, such that the supporting arm 5 is moved upward according to the double arrow 11 into the right-hand representation in FIG. 2, in such a manner that the bottle 2 is now positioned in an inverse manner. The star or plate, on which the device 1 is positioned, is indicated by the broken line and given the reference 12.

In the example represented in FIG. 3, the bottle 2 is held in a gripper 4′ in the device given the reference 1′, elements of the design in FIG. 3 that are operatively identical to those in FIG. 2 having the same references, however supplemented by an apostrophe'.

In the exemplary embodiment in FIG. 3, the drive element that brings about the pivoting in this case comprises a spring-loaded rod 13 that is secured to the pivoting element 5 and has a C-shaped sliding claw 14, which slides along a guide rod, not shown in any more detail, in engagement with said guide rod and is displaced in this manner in its spatial position, in such a manner that the supporting arm 5′ is pivoted upward as shown by the double arrow 11′ out of the left-hand position in FIG. 3 into the right-hand position in FIG. 3. This pivoting movement is repeated in three positions in FIG. 4.

FIGS. 2 and 3 also indicate that the gripping arms of the gripper 4 or 4′ are provided on a resilient element, which makes a certain degree of resilient deforming possible for extending the gripping arms. Consequently it is possible to compensate for any slight asynchronicities between the transfer positions from the star 12, e.g. into the rinser 3 and back.

As shown in the bottom image in FIG. 4, the supporting arm 5′ moves within a range that ensures that, for example, the spray nozzle 15 of the rinser 3 is not contacted, such that in this way it is not urgently necessary for rinser and star 12 to have to be moved completely in tune with one another.

Naturally, the described exemplary embodiment of the invention can still be modified in many respects without departing from the inventive concept, namely the concept that as small and compact a method of construction as possible is provided for the device 1, in such a way that a rinser is able to be dimensioned in a smaller manner, for example making better and further-developed rinsing methods possible. Even dry aseptic rinsers that use H₂O₂ can be used, since these latter are themselves not able to pivot bottles it now means that the bottles pivoted into the inverted position are also able to be processed by said dry aseptic rinsers. If the bottles are inverted early, as is possible using the present invention, any particles of dirt in the bottles, where applicable, are able to fall out; longer drip-dry times are possible such that there is less residual water and consequently the risk of recontamination is smaller.

1. An apparatus for pivoting a bottle between a suspended position and an inverted position, said apparatus comprising:
a drive element disposed on a star positioned in the direct vicinity of a rinser;
a rotational element acted upon by a drive element, the rotational element including
a rotational shaft, and
a support arm operatively coupled to the shaft; and
a gripper coupled to the rotational element by the support arm.

2. The apparatus of claim 1, wherein the star is positioned in a contact-free manner next to the rinser.

3. The apparatus of claim 1, wherein the rotational element comprises a gear wheel, and wherein the drive element comprises a push rod having teeth for engaging the gear wheel.

4. The apparatus of claim 1, wherein the drive element comprises a cable or belt and a push rod for acting upon the cable or belt.

5. The apparatus of claim 4, wherein the push rod is provided at its free end with a guide element.

6. The apparatus of claim 5, wherein the guide element comprises a wheel roller, the apparatus further comprising a rocker face for acting upon the wheel roller and for exerting a thrust movement onto the push rod.

7. The apparatus of claim 4, further comprising a restoring spring coupled to the push rod.

8. The apparatus of claim 4, further comprising a guard rail surrounding the push rod.

9. The apparatus of claim 1, further comprising:
a guide rod; and
a spring-loaded gripping arm for pivoting the rotational element and engaging the guide rod, the gripping arm including a C-shaped sliding claw.

10. The apparatus of claim 1, wherein the gripper comprises an active gripper for grasping a neck of the bottle.

11. The apparatus of claim 1, wherein the gripper is mounted so as to have a selected resilience.

12. The apparatus of claim 1, further comprising a gear wheel for coupling the rotational element to the drive element.

13. The apparatus of claim 2, further comprising a second star positioned in a contact free manner next to the rinser.

14. The apparatus of claim 5, wherein the guide element comprises a wheel roller.

15. The apparatus of claim 1, wherein the gripper comprises a passive gripper for grasping a neck of the bottle.

16. The apparatus of claim 1, wherein the gripper is rotatable on both sides in a horizontal direction thereof.
